(19) United States
(12) Patent Application Publication
(10) Pub. No.: US 2026/0300313 A1
(43) Pub. Date: Oct. 1, 2026

(54) AUTOMATED SOURCE DATA ANALYSIS, MAPPING, AND TRANSFORMATION SYSTEM FOR THIRD-PARTY SOFTWARE INTEGRATION

(71) Applicants: Patrick Robak, Rockville Centre, NY (US); Partha Bhattacharya, Hyderabad (IN); Amitava Ghosh, Kendall Park, NJ (US); Robert Jakobsze, Glen Cove, NY (US); Ramana Rachakonda, Monmouth Junction, NJ (US)

(72) Inventors: Patrick Robak, Rockville Centre, NY (US); Partha Bhattacharya, Hyderabad (IN); Amitava Ghosh, Kendall Park, NJ (US); Robert Jakobsze, Glen Cove, NY (US); Ramana Rachakonda, Monmouth Junction, NJ (US)

(21) Appl. No.: 19/630,990

(22) Filed: Mar. 27, 2026

Related U.S. Application Data
(60) Provisional application No. 63/779,663, filed on Mar. 28, 2025.

(51) Int. Cl. G06F 16/25

(52) U.S. Cl. CPC G06F 16/254

(57) ABSTRACT

A method and system of integrating source data into a target application by connecting to a designated source system, retrieving metadata for multiple source objects, and analyzing the metadata with an artificial-intelligence model to determine structural characteristics, data-quality indicators, and interrelationships. Based on these determinations, the artificial-intelligence model generates one or more candidate source-to-target mappings and determines whether each candidate satisfies at least one requirement of a target schema of the target application. When satisfied, the system codifies a data-transformation pipeline configured to transform the source data and load the transformed data into the target application, and then loads the transformed data.

### BACKGROUND OF THE INVENTION

### 1. FIELD OF THE INVENTION

The present invention relates to an AI-powered system for performing data analysis, mapping, and transformation of source data for integration with third-party software applications. This application claims priority to U.S. Provisional Application No. 63/779,663, filed Mar. 28, 2025.

### 2. Description of the Related Art

Financial Crime Compliance (FCC) refers to the policies and procedures implemented by financial institutions in order to detect, prevent, and report financial crimes such as money laundering, tax evasion, fraud, and other illicit activities. Adherence to FCC requirements is necessary for banks and financial institutions to ensure they meet regulatory standards and effectively combat illicit financial practices. Institutions that fail to maintain compliant FCC programs face significant legal, financial, and reputational consequences. Because FCC systems depend heavily on high-quality, well-structured data, the work needed to prepare that data is both essential and increasingly burdensome.

Business analysts are typically responsible for gathering source data to meet the technical and functional requirements of FCC models. These analysts create detailed source-to-target mapping specifications for the development team to use in coding. To perform this work effectively, analysts must possess a deep familiarity with the FCC application's target data model, a strong understanding of the financial institution's often fragmented and poorly documented source systems, and subject-matter knowledge of the institution's products, services, and operational practices. It is rare for analysts to hold all three of these competencies simultaneously. As a result, teams commonly face bottlenecks, rework, misinterpretations, and data quality gaps that undermine the accuracy and reliability of FCC models.

These challenges contribute directly to the escalating costs associated with FCC programs. A typical FCC implementation (for example, AML transaction monitoring, KYC/CDD onboarding, sanctions screening, or trade surveillance) takes approximately 12 to 24 months to complete and incurs expenses in the multimillion-dollar range. A disproportionate amount of this time and money is spent performing manual data discovery, analysis, mapping, and transformation work-efforts that are essential, as the effectiveness of the system relies heavily on the quality of the underlying data. These tasks are slow and labor-intensive, and because they rely on manual processes, they are susceptible to inefficiencies and errors, which ultimately may result in inaccurate alerts, model performance issues, and downstream regulatory findings.

Compounding these challenges, financial institutions often operate across heterogeneous core banking, trading, payments, and CRM systems whose schemas are opaque or inconsistently documented. Access to knowledgeable FCC data subject-matter experts is limited, and internal data landscapes frequently contain overlapping, inconsistent, or stale information. These systemic complexities lead to repeated delays, inconsistent data integration, and recurring issues raised by internal model validation teams, internal audit, and external regulators.

The considerable time and financial resources dedicated to repetitive analysis, combined with the need for extensive knowledge and the risk of errors in the early stages of implementation, present significant challenges. Artificial intelligence/machine learning technologies offer the potential to address these challenges by automating the data work that FCC programs traditionally perform manually. There is a strong need for a system that can integrate artificial intelligence/machine learning technology with FCC domain expertise to automatically interpret and profile source data, assign business meaning to attributes, determine relationships across disparate systems, generate source-to-target mappings aligned to complex FCC data models, and produce the transformation logic and documentation required to operationalize these mappings. Such a system must also be capable of continuously assessing data quality and enforcing governance controls so that only high-quality, validated data feeds FCC systems. Such a system would streamline these processes and significantly reduce the cost, time, and error-related risks typically associated with FCC implementations.

### SUMMARY OF THE INVENTION

Disclosed is an AI-powered, automated data analysis, mapping, and transformation system designed to streamline the complex and time-consuming process of mapping source data to any third-party software application, such as for example, accurately delivering FCC responsibilities in hours rather than months. In one embodiment, the system reduces end-to-end data discovery, mapping, and transformation efforts from approximately eight months to roughly one month, shortening overall project timelines by about 25%-50% and generating cost savings exceeding $1 million. These efficiencies are achieved by automating analysis, mapping, documentation, and code generation while simultaneously enforcing data-quality and lineage controls. The system leverages AI/ML to automate discovery, mapping, documentation, and pipeline generation. All requirements, features, and artifacts produced by the system are expressly optimized for financial datasets that feed FCC controls.

In one aspect, the system is optimized for financial data pipelines that support Financial Crime Compliance (FCC) controls. To satisfy the specialized requirements of AML, KYC/CDD, sanctions screening, and trade surveillance programs, the system prioritizes banking and market data entities. The system incorporates FCC-relevant semantics directly into its analysis, including beneficial ownership connections, customer and account hierarchy relationships, currency normalization dependencies, transaction directionality, and domain-specific transaction types. To ensure that outputs meet regulatory expectations, the system applies control-grade guardrails throughout the data life cycle. These include masking of PII, PCI, and employee-related fields; enforcement of referential integrity against status and type tables; and consistency checks for currency and FX rate alignment. In one embodiment, the system produces regulator-ready evidence for each stage of the pipeline, including ERD snapshots, data dictionaries, profiling reports, mapping specifications, generated code, lineage visualizations, approvals, and recorded governance exceptions. These artifacts support the full FCC lifecycle (from model development, to independent validation, to audit and examination).

The system discovers and profiles source data, where it analyzes, reviews, and summarizes the data's structure, content, and interrelationships. The system evaluates how data is organized, how tables relate to one another, and how individual attributes behave statistically. In one embodiment the system assigns meaning to data tables (such as Transactions, Accounts, and Customers) and attributes (such as Transaction ID, Account Number, and Amount), ensuring that all elements of the data are accurately understood. In one embodiment, the system assesses critical data quality factors, including accuracy, completeness, consistency, timeliness, and accessibility, guaranteeing that the data is primed for successful integration. In one embodiment, this profiling and subsequent analysis of the source data is performed using artificial intelligence. By interpreting both structural and semantic relationships, the system ensures that each element of the data is accurately understood within the relevant (e.g. financial) context.

The system thereafter automatically generates source-to-target mappings and documentation, as per the client's specific business requirements, that align with the target software's data types, constraints, and dependencies. In one embodiment, any mappings that require manual intervention are flagged for review, ensuring that issues are addressed proactively. In one embodiment, 4-eye review is enforced, a validation process that requires at least two users to approve a mapping before it is accepted. In one embodiment, sample output data is generated for the user to visualize the end product before any transformations are actually applied. In one embodiment, the source-to-target mapping and documentation is performed using artificial intelligence.

The system then automatically extracts relevant data from the source and applies transformations in accordance with the specifications produced by its source-to-target mappings. In one embodiment, an output file is produced that contains all the necessary code to extract and transform the relevant source data and load it in the target software application. In one embodiment, the transformed output can be integrated with other third-party data management and integration software. In one embodiment, the system continuously monitors data quality, preventing degradation over time and ensuring that the integration remains seamless as the system evolves. In one embodiment, the transformation is performed using artificial intelligence.

By automating the data mapping process for third-party software applications, the system significantly accelerates project timelines, leading to faster integration and more efficient use of resources. For instance, tasks that typically take eight months to complete can now be finished in less than one month, reducing overall project timelines by 30% and generating cost savings of over $1 million. This automation enhances the time-to-value on software investments made by financial institutions and ensures high-quality data integration with minimal error risk.

In one aspect all requirements, features, and artifacts produced by the system are expressly optimized for financial datasets that feed FCC controls. Data discovery is tailored to banking and trading entities. Data source-to-target mapping enforces referential and constraint integrity consistent with FCC vendor data models where the system will output regulator-ready pipelines. Governance, security, and traceability features provide the transparency and evidence expected by model validators, internal audit, and regulatory examiners.

In some aspects, the techniques described herein relate to a computer-implemented system and method to integrate source data into a target financial crime compliance (FCC) application. In such an implementation, the method may include connecting to a designated source database to retrieve metadata associated with multiple source objects, and analyzing that metadata with an artificial intelligence model to determine structural characteristics, data-quality indicators, and interrelationships among the source objects. Based on these determinations, the artificial intelligence model may generate one or more candidate source-to-target mappings for the target FCC application. If a candidate mapping satisfies at least one requirement of a target schema of the FCC application, the method may further include codifying a data-transformation pipeline configured to transform the source data in accordance with the approved mapping and to load the transformed data into the FCC application. After codification, the method may proceed by loading the transformed data into the target FCC application.

In some aspects, the techniques described herein relate to the use of artificial intelligence to interpret, analyze, and derive insights from a range of information extracted from the source database. As described herein, the system may utilize source database tables, attributes, values, metadata, and documentation as inputs to the AI model, along with source table names, schemas, values, and indexes that define the structure of the underlying data. The AI model may also process source attribute names, data types, lengths, defaults, and constraints as well as source attribute values and any available source documentation, enabling the system to determine structural characteristics and inter-relationships. In some implementations, these inputs permit the AI to generate higher-level artifacts, as the system integrates multiple inputs into an artificial intelligence module to generate the corresponding output value including data-quality assessments, entity-relationship diagrams, functional descriptions, data dictionaries, and identification of duplicate or orphaned data. Across these embodiments, artificial intelligence draws from a combination of metadata, schema definitions, example values, constraints, structural relationships, and written documentation, enabling automated data discovery, mapping, and transformation for the target application.

The system may further include a memory configured to store metadata and intermediate analytical outputs. In one aspect the memory can be configured to store prior mapping decisions for use in subsequent processing. The memory component may be a persistent memory that the processor can read and update across multiple executions of the system. In some aspects, the memory is leveraged by the artificial intelligence module to refine future mapping recommendations.

In some aspects, the method includes assigning a governance designation to one or more source objects. In such implementations, the governance designation may be determined based on the structural characteristics and data-quality indicators identified during the system's automated analysis of the underlying source data.

In some aspects, the method includes generating an entity-relationship diagram that reflects the interrelationships among the plurality of source objects. This diagram may be produced automatically by the system upon identifying links, references, or dependencies within the analyzed metadata.

In some aspects, the method includes generating functional descriptions that assign semantic meaning to the source objects. These descriptions may provide contextual insight into the purpose or intended use of each table, attribute, or dataset within the larger source environment.

In some aspects, the method includes flagging any candidate source-to-target mapping that has a confidence score below a configurable threshold. Such flagging may prompt further review or indicate that additional contextual input is required before the mapping is accepted.

In some aspects, the techniques described herein relate to a computer system that includes a user interface, a memory, and one or more processors configured to facilitate automated integration of source data into a target application. In such implementations, the system may operate by connecting to a designated source system to retrieve metadata associated with multiple source objects, and by analyzing that metadata using an artificial intelligence model to identify structural characteristics, data-quality indicators, and interrelationships among the source objects. Based on the AI-derived insights, the system may generate one or more candidate source-to-target mappings for the target application. If a candidate mapping satisfies one or more requirements of the target application's schema, the system may then codify a data-transformation pipeline configured to transform the source data according to the approved mapping and load the resulting transformed data into the target application. In some aspects, the processors may further be configured to initiate execution of the codified pipeline to complete the loading of the transformed data into the target application.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

Various embodiments are disclosed in the following detailed description and the accompanying drawings, in which:

FIG. 1 is an architectural diagram of a decisioning platform of each step of the disclosed invention, in accordance with one embodiment of the present invention.

FIG. 2 is a flowchart of the method in accordance with one embodiment of the present invention.

FIG. 3 is a flowchart of the method in accordance with one embodiment of the present invention.

The following detailed description of specific embodiments of the inventive subject matter will be better understood when read in conjunction with the appended drawings. As used herein, an element or step recited in the singular and proceeded with the word “a” or “an” should be understood as not excluding plural of said element or step, unless such exclusion is explicitly stated. Furthermore, references to “embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

### DETAILED DESCRIPTION OF THE EXEMPLARY EMBODIMENTS

Reference will now be made in detail to embodiments of the invention, examples of which are illustrated in the accompanying drawings. Embodiments consistent with the present invention relate to systems and methods for the discovery, source-to-target mapping, and transformation of data from a data source to a target.

“Source” refers to the original data or system from which the data is being extracted or discovered. It is the starting point where the data resides before being processed by the system.

“Target” refers to the destination system or software where the data is being transferred or integrated after being processed by the system. Specifically, the target represents the data model or framework that the source data must align with in order to be compatible within the destination environment.

Any terms used in the application that are not explicitly defined will be understood to carry the meaning commonly attributed to them by someone with ordinary skill in the relevant art within the context of the present invention's disclosure.

In accordance with an aspect of the present invention, the invention relates to an AI-powered system for performing data analysis (discovery), mapping, and transformation of source data for integration with a target third-party software. The system is designed to analyze, review, and summarize source data, enabling users to extract valuable insights from complex datasets. The system understands the structure, content, and interrelationships within the data, which allows it to discern how different data points are connected and how they contribute to the overall context. The system assigns meaning to various components, such as tables, which may represent entities like transactions, accounts, customers, and other relevant categories. It also identifies and assigns meaning to attributes within those tables, such as transaction IDs, account numbers, amounts, and other key identifiers, ensuring that each piece of data is appropriately categorized. In addition to interpreting the data, the system measures the quality of the dataset by evaluating factors like accuracy, completeness, consistency, timeliness, and accessibility.

In one embodiment, the system is fully automated. By automating the data mapping, transformation, and monitoring processes, the system ensures that data feeding the relevant target models (for example, FCC models) is complete, accurate, and consistent. The platform breaks down knowledge silos, offering transparency into the data's lineage and quality. This level of visibility enhances the trust and confidence of validators, auditors, and regulators, ensuring that the models are built on a solid foundation of reliable data and that all compliance requirements are met.

The method and system follow cloud-native design and is vendor agnostic. It works both in public cloud infrastructure and private cloud infrastructure. The system is designed to leverage both open-source AI models and closed-source AI models, the latter being proprietary and typically accessible through paid licenses or subscriptions.

In one embodiment, the system operates in three steps. Each step encompasses a series of distinct, smaller phases/tasks for the system to execute. In one embodiment, the system features a system management portal which contains a specially designed user interface for each core step/module of the system.

An exemplary embodiment of the system has the system analyzing and profiling source data by establishing a connection to a user-selected source and then reviewing the data's structure, content, and interrelationships to identify and extract the information necessary for accurate and complete processing. As part of this initial analysis, the system assigns business meaning to data tables (e.g., Transactions, Accounts, Customers) and their attributes (e.g., Transaction ID, Account Number, Amount) to ensure all data elements are properly understood.

In one embodiment, the system also assesses key data quality factors such as accuracy, completeness, consistency, timeliness, and accessibility to ensure the data is ready for integration. In one embodiment, the system leverages artificial intelligence to evaluate source database tables, attributes, values, metadata, and available documentation; generate concise, context-aware descriptions of tables and attributes in the financial-services domain; and apply advanced profiling metrics to detect patterns, trends, structural regularities, content characteristics, and interrelationships across the source data. The module analyzes, reviews, and summarizes the source data, interprets structural and semantic relationships, assigns business meaning to tables and attributes, and measures data quality across all relevant dimensions.

The system normalizes heterogeneous inputs (such as table names, schemas, data types, lengths, defaults, constraints, sample values, and documentation artifacts) into a canonical metadata format. Each input dimension is assigned a configurable weight that contributes to an overall confidence score used to gate downstream outputs. This weighting mechanism allows the platform to prioritize high-fidelity signals, like well-formed constraints and stable value distributions, while de-emphasizing lower-quality signals, such as sparse samples or conflicting documentation.

Data is mapped to the target software's key data elements to align with data types, constraints, and dependencies, ensuring compatibility and validity. The data is then transformed and loaded according to the specified timing and frequency, with the process automated to maintain consistency and reliability. To maintain transparency and traceability, detailed documentation is automatically generated, providing a clear record of the entire process. In one embodiment, if any mappings require manual intervention, these are flagged for review, ensuring any issues are addressed promptly.

Additionally, one embodiment of the system includes perpetual monitoring to guarantee that data quality remains high and does not degrade over time, therefore permitting the system to proactively identify and correct any potential problems found within. This monitoring process is designed to be automated, and in one embodiment maintains seamless integration as the system evolves and consistently ensures that the data within the system is continuously up to date. This approach allows the system to work efficiently across different cloud environments while guaranteeing accurate and reliable data transformations and integrations for a variety of use cases.

The implementation of a new FCC vendor application presents an example use case for this system, as it involves mapping unknown and poorly documented sources to an entirely new target data model under the pressure of an aggressive project timeline. This process, which would traditionally require extensive manual effort and detailed knowledge of the sources, is streamlined and accelerated by the system. With its ability to automatically extract, transform, and load data while adhering to strict data constraints, the system ensures that the mapping process is both efficient and accurate. As a result, users are able to approach a specific task with a high degree of confidence, reducing the time spent on manually intensive tasks and thereby allowing workers to focus on other complex deliverables within the project. The system's support ensures that critical deadlines are met without compromising the integrity of the data.

Additional FCC-specific use cases include: sanctions and watchlist screening feeds, in which the system normalizes customer, account, and payment attributes (such as names, addresses, transaction direction, and currency) to supply screening engines; transaction monitoring and customer risk rating; trade surveillance; and KYC/CDD analysis.

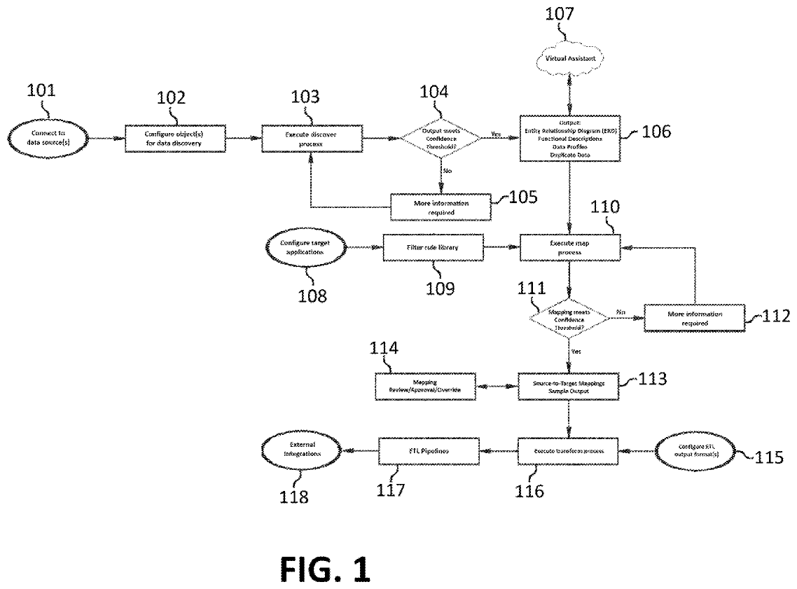

FIG. 1 is a flowchart illustrating one embodiment of the present invention, outlining various potential pathways based on specific phases/tasks within the system's integration with any third-party software application.

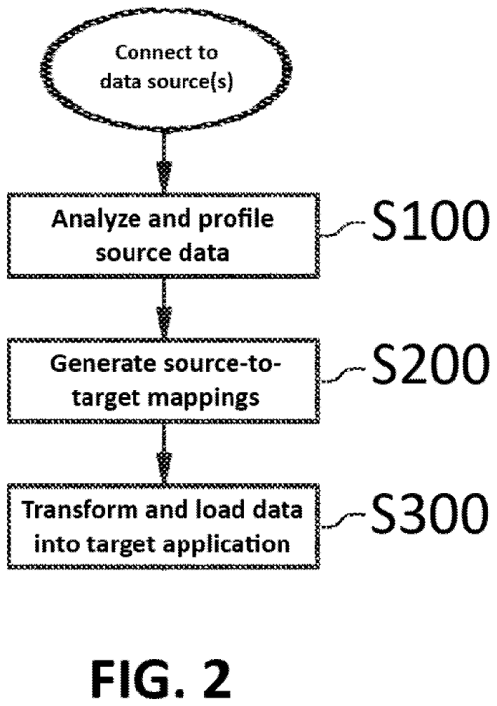

FIG. 2 is a flowchart of the method in accordance with the invention. The exemplary embodiment of the system in FIG. 2 features a Step S100, a Step S200, and a Step S300, wherein each step further contains individual phases/tasks for the system to undertake.

An exemplary embodiment of Step S100 involves the system analyzing and profiling the source data, reviewing its structure, content, and interrelationships. It establishes a connection with the predetermined source, identifies, and extracts necessary information while ensuring accuracy and completeness. The user may connect securely to heterogeneous sources, including but not limited to RDBMS, NoSQL systems, data lakes and lakehouses, and structured files such as CSV, XML, JSON, and Parquet. For sensitive environments, the interface may require the user to explicitly select a data source and provide credentials. Step S100 also assigns meaning to data tables and attributes, and assesses data quality factors like accuracy, completeness, consistency, timeliness, and accessibility.

An exemplary embodiment of Step S200 automates the data mapping process by recommending transformations that align with the target software's data types, constraints, and dependencies, ensuring compatibility and validity.

An exemplary embodiment of Step S300 transforms the mapped data into the target system. In one embodiment the Step S300 includes perpetual monitoring to maintain high data quality over time, automatically identifying and correcting potential issues.

An exemplary embodiment of the system begins S100 with the system connecting to a data source 101. The user can connect to and interpret data sources of many different types, including structured and unstructured data. These include, but are not limited to RDMS, NoSQL, Data Lakes, Lakehouses, CSV, XML, JSON, Parquet, and other file types. The system rapidly accelerates the discovery, analysis, and profiling of unknown and poorly documented data sources. In one embodiment, artificial Intelligence is used within the system in order to evaluate source database tables, attributes, values, metadata, and documentation. The system then subsequently interprets the source data through the assistance of AI and performs a statistical analysis. In one embodiment, the proposed invention does not store any source data, only the relevant metadata and the insights/outputs it produces. In one embodiment, the system applies advanced profiling to detect patterns, trends, structure, content, and interrelationships of the source data.

Upon connection to a data source 101, the user can then configure which source objects to include or exclude from the system 102. In one embodiment, users selectively include or exclude schemas, tables, columns, or views before any profiling occurs, and these scope settings may be saved per project or per environment (e.g., Development, UAT, Production). Prior to analysis, the user may also apply optional filters such as patterns or tags (e.g., “customer” or “transactional”) to focus computation on in-scope assets while deferring highly sensitive columns until privacy controls are confirmed.

In one embodiment, based on the available inputs, the system utilizes artificial intelligence, such as a fine-tuned LLM, in order to generate relevant outputs 103. The more inputs available to the system, the more accurate the outputs are expected to be. System inputs include but are not limited to source table names, schemas, values, and indexes, which help define the structure and organization of the data. Additionally, source attribute names, data types, lengths, defaults, and constraints are gathered to ensure that the data is understood in its entirety, including any limitations or rules that apply to it. The system also considers the source attribute values, as well as any available source documentation.

After evaluating the available inputs, the system outputs several key artifacts that detail the data source. In one embodiment, the system integrates multiple inputs into an artificial intelligence module to generate the corresponding output values. In one embodiment, the system evaluates the quality of the data by assessing the data's overall accuracy, completeness, consistency, timeliness, and accessibility using internally placed parameters. In one embodiment, outputs are scored and measured against a configurable threshold prior to being displayed 104. In one embodiment, any output not meeting the configurable confidence threshold is not displayed, unless more/higher quality input(s) are provided 105. In one embodiment, any output that does not meet the predetermined threshold is flagged as such and either requires modified module inputs or manual verification.

As part of the automated discovery process, the system normalizes available inputs (e.g. names, schemas, datatypes, lengths, defaults, constraints, indexes, value distributions, and documentation) into a canonical metadata model. It then performs structural inference (including primary and foreign key discovery and relationship identification), computes profile statistics (including uniqueness, missingness, distributional properties, and time-based freshness), and conducts preliminary governance detection (including quality and privacy indicators) to support downstream rules and confidence scoring. In one embodiment, the profiling process also computes per-column statistics, including uniqueness percentage and missingness percentage, which are included in the display only when the corresponding artifact meets or exceeds the confidence threshold.

If the output meets the confidence threshold, an Entity Relationship Diagram (ERD) 106 can be generated and accessed by the user. The Entity Relationship Diagram is a type of flowchart that depicts the interconnectedness of entities, relationships and their attributes.

In one embodiment, Functional Descriptions can be generated 106. Functional Descriptions are clear, succinct, and accurate plain-English descriptions of each object and attribute that assigns them meaning in the relevant business context for which the system is being used.

In one embodiment, a Data Dictionary can be generated 106. A Data Dictionary includes field names, data types, lengths, formats, defaults, descriptions, and examples for each table-using a DB agnostic format.

In one embodiment, Data Profiles can be generated 106. Data Profiles are an assessment of the data that uses a combination of tools, algorithms, and business rules to create a high-level report of the data's conditions.

In one embodiment, duplicate and orphaned data can be identified 106. Duplicate data is data that is redundant within the same source or across multiple sources. This helps ensure the same transactions, customers, or accounts, are not loaded into the target application more than once. Orphaned data is data that is no longer associated with other records or entities within a source.

In one embodiment, the ERD, Functional Descriptions, Data Dictionary, Data Profiles, and identification of duplicate and orphaned data can all be generated by the use of artificial intelligence.

In one embodiment, the system features an AI-powered virtual assistant 107 (e.g. Copilot) that users can interact with to clarify system outputs and further analyze the source data beyond what has been initially presented. Users can engage the virtual assistant 107 to gain a deeper understanding of the data by asking the AI specific questions regarding the underlying inputs, and their relationships with the initial outputs provided. In one embodiment, users can interact with the virtual assistant 107 to have the AI clarify or further analyze source databases, tables, attributes, and their interrelationships with other inputs or with the available outputs.

The system at S200 leverages the relevant inputs to propose detailed source-to-target mappings for any target application 110. In one embodiment the system utilizes artificial intelligence in order to perform the source-to-target mapping for the target applications. The system proposes source-to-target mappings using Discover artifacts and the filtered rule set. For each target attribute, it identifies candidate source elements, applies possible transformations and validates compliance with target schema constraints. In one embodiment, mappings are scored and measured against a configurable threshold prior to being displayed 111. Each mapping may receive a confidence score influenced by structural quality, metadata alignment, and distributional stability. If more information is required, users may supply additional samples or specify rule refinements. The system then re-scores the mappings and re-evaluates threshold satisfaction. In one embodiment, any mapping not meeting the configurable confidence threshold is not displayed, unless more/higher quality input is provided 112. If the mapping meets the confidence threshold, the system will provide a mapping output 113.

In one embodiment, the system will output detailed and exportable source-to-target mapping specifications for each critical target application attribute. In one example, the proposed detailed source-to-target mappings may be applied for any target FCC application.

In one embodiment, the user can configure which target application and modules they intend to map the source data to 108. In one embodiment, the system will incorporate mapping rules for the corresponding destination database and prioritize these rules based on an internal constraint. In one example, the system will include mapping rules for all significant Financial Crime Compliance applications, beginning with the most prevalent. This action filters a curated mapping rule library down to only the relevant mappings 109.

The system references a comprehensive, SME-curated mapping rule library encoding target data types, constraints, dependencies, and transformation best practices. The system may suggest only those transformations that comply with the target's structural and semantic requirements. When multiple candidate transformations exist, the rule library's precedence framework ensures deterministic selection and presents the decision rationale. In one embodiment, the mapping rule library includes vendor-specific and domain-agnostic rules organized into precedence tiers, enabling systematic evaluation when multiple rules may apply. In one embodiment, the mapping rule library is curated by information from subject matter experts. In one embodiment, a user may curate a mapping rule library and/or edit a pre-existing mapping rule library. In one example, the system will include mapping rules for all significant Financial Crime Compliance applications, beginning with the most prevalent. The curated rule library may be prioritized according to target side constraints and usage frequency and may include prebuilt rule sets for leading FCC applications and modules. In one embodiment, users can extend, edit, or replace rule sets to accommodate institution specific standards. This action filters a curated mapping rule library down to only the relevant mappings 109. In one embodiment, the knowledge base of the mapping rule library may be expanded and improved over time.

After evaluating the available inputs, the system will output detailed and exportable source-to-target mapping specifications for each critical target application attribute. In one example, the proposed detailed source-to-target mappings may be applied for any target FCC application. The system outputs 113 both the comprehensive mapping specifications and a real-time sample output that visualizes the applied transformations and constraint effects, with privacy-flagged fields masked as needed. In one example, each mapping specification enumerates the source table, source attribute, source data type, target table, target attribute, target data type, required transformations, and an illustrative sample output, and supports both full (Day 0) load and incremental load variants. The Full/Day 0 load represents a full refresh of the source data without any time-based constraints. This is used upon initialization of the system, or in the event of an issue that warrants a clean baseline. The Incremental load represents delta batches, typically daily, that only include changes in the source data. This is used in an active Production system to avoid loading large volumes of unnecessary data where nothing has changed.

In one embodiment, artificial intelligence performs the source-to-target mapping by evaluating the available inputs and having the system output detailed, exportable specifications for each critical target attribute. These outputs are available as both Full/Day 0 load and Incremental load variants.

In one embodiment, each mapping can be manually reviewed in the user interface and be either approved or overwritten, if deemed necessary 114. In one embodiment, each mapping will be accompanied by a real-time output sample to visualize the effects of any applied transformations, thus allowing the user to see if there are any necessary changes. In one embodiment, the module comprises automated scripts that validate the mapping output to ensure it conforms to the necessary data types, constraints, and dependencies.

In one embodiment, the module comprises 4-eye review: a validation that requires at least two users to approve a mapping. These validations can be applied to specific target attributes, or across all mappings. In one embodiment, the module comprises a confidence score where all mappings generated by the system are measured against a configurable confidence score. Any output that does not meet the predetermined threshold of the configurable confidence score is flagged as such and either requires modified module inputs or manual verification.

In one embodiment, the module comprises a reverse mapper, where rather than use insights taken from the Step S100 and the rule library as inputs to produce source-to-target mappings, the system uses existing ETL code and scripts as inputs to reverse engineer existing mappings. This is useful in cases where the current transformations and pipelines are poorly documented but need to be validated. In one embodiment, these reverse mappings can also be compared to those the proposed invention would typically generate to identify potential gaps for remediation.

The mapping output will subsequently lead to initializing Step S300 of the system 116. After the system generates data mapping specifications, the system consumes those instructions as an input to autonomously generate ETL code/pipelines that can be executed manually or through a job scheduling tool. ETL code and pipelines come in different forms, including, but not limited to SQL, Python, Apache Airflow, Apache Spark, and Google Composer. As such, the Step S300 of the system can also be initialized by the configuration of ETL output formats 115.

In one embodiment, the Step S300 utilizes artificial intelligence, such as a fine-tuned LLM, to autonomously codify the specifications produced by the system's Step S200. Step S300 will output a codification of the detailed mapping specifications that can be executed either manually or through a job scheduler to pull data from the data sources, transform it, and load it into the target. In one embodiment, the system implements data governance, reconciliation, and completeness checks that perpetually monitor data quality. These checks can be subsequently shown as feedback to the user. In one embodiment, this data quality feedback measurement is performed using artificial intelligence.

In order to productionize ETL pipelines 117, integration with key related systems is a necessity 118. Organizations will have existing infrastructure and approved technology stacks already in place across their IT departments. As such, the proposed invention integrates with industry standard data management and integration tools, such as Informatica and StreamSets, and job schedulers, such as TWS and Autosys, for workflow management and monitoring. In one embodiment, users visualize and export the end-to-end flow for fully transparent, auditable, and traceable data lineage.

In one embodiment, users may visualize and export the complete end-to-end flow for transparent, auditable, and traceable data lineage. Exportable evidence bundles may include ERD snapshots, data dictionaries, profile statistics, rule catalogs with statuses, governance findings, exception histories, four-eye approvals, lineage graphs, and execution logs. Each export is version-pinned to the corresponding mapping and code release and may be digitally signed to support regulatory and audit requirements.

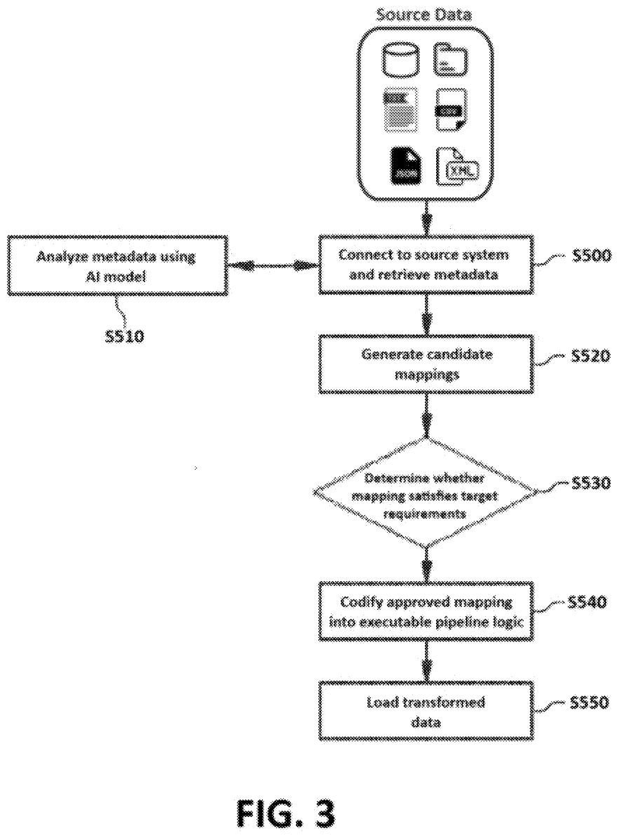

Reference now will be made with respect to FIG. 3, which illustrates an embodiment of the system when implemented for a Financial Crime Compliance (FCC) application. The system establishes a secure connection to a designated FCC data source S500 and retrieving metadata for a plurality of source objects relevant to AML, KYC/CDD, sanctions screening, and trade surveillance, such as Customers, Accounts, Transactions/Payments, and reference tables (e.g., Country, Currency, FX Rate, Direction, Transaction Type). The retrieved metadata may include table structures, attribute names and data types, lengths, defaults, constraints and indexes, representative values or value distributions, and any associated documentation needed to interpret the FCC domain context. The system then analyzes, via an artificial intelligence model, the collected metadata S510 to determine structural characteristics, data-quality indicators (such as accuracy, completeness, uniqueness, timeliness, and consistency), and interrelationships among the FCC-relevant source objects (for example, linking Transactions to Accounts and Currency, and linking Customers to Accounts via customer-account cross-reference), while interpreting the data's semantics, constraints, example values, and written documentation in the FCC context. The system then generates S520, using the artificial intelligence model and based on the determined structural characteristics, data-quality indicators, and interrelationships, one or more candidate source-to-target mappings aligned to the selected FCC target application schema (e.g., mapping Customer, Account, and Transaction fields, including directionality, amount/currency normalization, and type/status codes, to the target FCC model). The system makes a determination based on each candidate mapping S530 against at least one requirement of the FCC target schema, such as type compatibility, constraint satisfaction, referential coverage, and other structural or semantic rules of the FCC application. Mappings that do not satisfy the requirements, or that fall below a confidence threshold, may be rejected, withheld, or flagged for further review.

Upon satisfaction of the FCC target schema requirements, the system receives the approved source-to-target mapping, which defines the correspondence between source attributes and target attributes and specifies any required transformation logic. Based on this approved mapping, the system automatically generates executable code S540 that implements the defined data movements and transformations. In this stage, the system codifies the mapping into a complete data-transformation pipeline configured to extract the relevant source data, apply the required transformations (including, e.g., reformatting, currency conversions, and masking of sensitive information) and prepare the resulting dataset for loading into the target FCC application. The output of this codification process is production-ready ETL code or pipeline definitions (such as SQL scripts, Python code, or Spark/Airflow workflows) that implement the approved mapping without requiring manual coding by a user. The system then executes the codified pipeline to load the transformed dataset into the FCC application S550, thereby completing the integration and enabling downstream FCC controls such as sanctions screening, transaction monitoring, customer risk-rating, and trade-surveillance activities.

In one embodiment, the system features a specially designed user interface (UI) to configure and interact with each core system functionality. In one embodiment, the UI features a target application configuration, where the target application interface is a way to filter the mapping rule library to only map those fields within the scope of each specific project. The user specifies the target application, modules, rules, and even field usage.

In one embodiment the UI is organized into dedicated workspaces, each tailored to the tasks, workflows, and artifacts of its corresponding step in the system's three-step process. This modular structure allows users to navigate seamlessly across discovery, mapping, and transformation functions while maintaining contextual awareness of the underlying data and operations.

In one embodiment, The UI features a Discover Explorer, which is the primary screen of Step S100. The Discover Explorer displays all of the relevant outputs in a user-friendly and interactive manner. In one embodiment, the Discover Explorer contains a customer table, wherein the user can see contained information about the organizations and individuals that make up the bank's customer base. The customer table contains information including but not limited to the customer's name, address, contact information, birth date, country of citizenship, and their respective country codes. In one embodiment, the Discover Explorer contains the customer's account information and transaction history. In one embodiment, the Discover Explorer displays the phases/tasks and stated embodiments of the Step S100 including but not limited to the inputs and outputs of Step S100, any flagged outputs, the advanced profiling score, the configurable threshold score, identified duplicate and orphaned data, a means to use the AI virtual assistant, and any generated ERDs, Functional Descriptions, Data Dictionaries, and Data Profiles.

In one embodiment, the Discover Explorer presents discovery inputs and gated or flagged outputs, together with quality scores relative to a configurable threshold. It displays autogenerated artifacts, including Entity-Relationship Diagrams (ERDs), Functional Descriptions, Data Dictionaries, and Data Profiles, and surfaces field-level Data Quality and Data Privacy flags for rapid assessment. Users may access an AI-assisted Co-Pilot to obtain clarifications linking outputs to underlying evidence.

Where a live source is required, the Discover Explorer applies a connection gate prompting the user to select a data source and provide credentials prior to rendering table-level content. In one embodiment, the interface can render representative customer, account, and transaction views derived from source metadata and profiling to support rapid orientation while maintaining data-minimization principles. The Explorer further reports deduplication and orphan findings to prevent redundant loads and to surface records with broken referential associations.

In one embodiment, the Explorer renders an interactive ERD depicting discovered or declared relationships. Representative relationships include: Account linked to Account Status and Account Type; Customer Account (cross-reference) linking Customer and Account; Customer linked to Country, Customer Status, Tax ID Type, and Customer Type; Transaction linked to Account, Currency, Contra Account Type, Direction, and Transaction Type; and Currency linked to FX Rate. Stand-alone reference entities (e.g., Employee Type) may appear as independent nodes. Users may inspect keys, constraints, profiling indicators, and privacy flags associated with ERD nodes and edges.

In one embodiment, the Discover Explorer displays profiling results that are relevant to FCC use cases. These results include checks for missing values, uniqueness, outliers, timeliness, referential coverage, and distinct value changes for each object. For example, account data may show high missingness in certain registration fields and may include privacy-sensitive short-name attributes; trade data may show fully unique execution identifiers along with outlier patterns in state or volume fields; transaction data may show elevated missingness in contra-bank fields with suggestions for enrichment, as well as timeliness issues based on transaction timestamps; and referential tables may show coverage checks for items such as Account Status, Account Type, Direction, Transaction Type, Currency, and FX Rate

In one embodiment, object-level panels display key information for each entity, including a description, data-dictionary attributes such as primary and foreign keys, important constraints, profiling statistics like column-level uniqueness and missingness, and governance flags related to data quality and privacy. Representative entities shown in these panels may include Account, Trade, Customer, Customer Account (cross-reference), Country, Customer Status, Tax ID Type, Customer Type, Transaction, Currency, Contra Account Type, Direction, Transaction Type, FX Rate, and Employee Type.

The primary screen of Step S200 of the system is the Map Matrix. In one embodiment, the Map Matrix displays all of the relevant mappings in a user-friendly and interactive manner. In one embodiment, the Map Matrix contains a window, wherein the user can see the output produced by Step S200 of the system. In one embodiment, the Map Matrix contains a real-time output sample to visualize the effects of any applied transformations, thus allowing the user to see if there are any necessary changes. In one embodiment, the Map Matrix displays the phases/tasks and stated embodiments of Step S200 including but not limited to the configurable target applications and modules to map the source data to, the curated mapping rule library, the configurable threshold confidence scoring of the mappings, the 4-eye review function, the mapping outputs of Step S200, and the flagged outputs that do not meet the predetermined threshold of the configurable confidence score.

In one embodiment, the Map Matrix cross-references field-level Data Quality and Data Privacy flags produced during discovery to focus analyst attention on high-risk attributes before approval. This context-aware review preserves confidence gating and validation controls, ensuring that sensitive or low-quality inputs receive heightened scrutiny.

In one embodiment, the Map Matrix cross-references field-level Data Quality and Data Privacy flags produced during discovery to focus analyst attention on high-risk attributes before approval. This context-aware review preserves confidence gating and validation controls, ensuring that sensitive or low-quality inputs receive heightened scrutiny.

The Designer is the primary screen of Step S300 of the system. In one embodiment, the Designer allows users to create, modify, and manage processes. In one embodiment, the Designer allows users to see each individual data pipeline which will be used within Step S300 of the system. In one embodiment, the Designer displays the phases/tasks and stated embodiments of the Step S300 including but not limited to the autonomously generated ETL code/pipelines, the codification of the detailed mapping specifications, and feedback of the data quality of the transformed data.

The Designer surfaces all phases and tasks associated with the Step S300, including the codification of mapping specifications, the organization of transformation logic, and the display of data-quality feedback generated during Transform execution. Such feedback may include completeness checks, allowing users to evaluate the integrity of transformed data and identify areas requiring review before operational deployment.

In one embodiment, the Designer supports process management by providing a clear view of each transformation flow. Users may review the structure and organization of individual pipelines, inspect dependencies among source and target objects, and modify configuration settings as needed. The interface incorporates governance controls such that any changes to transformation logic or execution parameters remain subject to policy checks, appropriate approvals, and, where required, four-eye review prior to finalization.

The Designer also preserves context shared across modules. Selections and filters applied in the Discover Explorer and Map Matrix (such as chosen entities and governance flags) are retained within the Designer to ensure continuity throughout the workflow. This enables reviewers to evaluate transformation configurations with the same scope, quality indicators, and object relationships visible during earlier system steps.

In one embodiment, the system holds a data governance framework. The data governance framework is a set of rules and processes that manage data within the application. The purpose of the framework is to ensure the integrity, security, and compliance of data, and to establish a standard for how data is collected, organized, stored, and used. This makes it easier to streamline and scale data governance, maintain policy and regulatory compliance, democratize data, support collaboration, and build trust.

Data governance is enforced across the system's workflow. Within the Step S100, outputs are confidence-gated and flagged when they do not meet threshold criteria. Within Step S200, proposed mappings are subject to dual approval (four-eye review) combined with validation checks prior to activation. Within Step S300, reconciliation and completeness evaluations are embedded into processing flows, and lineage metadata is emitted to preserve traceability of transformations and data movements from source through target.

In one embodiment, a Governance interface exposes a configurable rule catalog that classifies policy checks by class (quality or privacy), type, description, and status. A canonical baseline set includes, by way of example, rules that detect duplicates, inconsistencies, outliers, incompleteness, staleness, and novel categories, as well as privacy classifications for personally identifiable information, payment card information, and employee data.

In one embodiment, each object presented in the discovery interface includes an embedded governance summary. This summary enumerates data-quality flags (for example, missing or stale business attributes) and data-privacy flags (for example, names, addresses, or contact fields), and recommendation for corrective actions. Rules bind to specific tables and columns based on profiling signals, including examples such as high missingness on account registration lines, sensitive identity attributes in customer records, or timeliness concerns on transaction timestamps.

In one embodiment, rule semantics and thresholds are tailored to the underlying data characteristics. Duplicate detection considers primary identifiers and configured similarity measures; outlier detection applies robust statistical approaches for numeric and temporal values; incompleteness triggers when missingness exceeds a defined limit; staleness flags when the latest observed date exceeds a policy window; and distinct-value checks identify newly introduced categories absent from referential sets.

In one embodiment, rule findings create trackable governance items with assigned owners, severities, and due dates.

In one embodiment, the system measures and reports the accuracy, completeness, consistency, timeliness, and accessibility of data quality elements at both the source and target levels on a perpetual basis.

In one embodiment, the data governance framework includes robust auditing functionalities that provide detailed records of every action taken within the system, whether conducted by a user or the system. This audit history helps ensure data security and regulatory compliance by monitoring when, how, and by whom changes are made.

The data lineage process within the system tracks the life cycle of data, including how it's generated, transformed, moved, and used across the system. In one embodiment, the data lineage process provides a detailed record of the data's origins, transformations, and movements. This lineage is presented to users as both a report and as a visualization within the system's user interface.

In one embodiment, lineage operates at column-level granularity, linking individual source columns to corresponding target fields through explicit transformation semantics (e.g., type conversions, concatenations, and conditional logic) defined by the system's specifications. The system further provides a time-lapse view of the ERD to visualize how schemas and relationships evolve over time (e.g. such as the introduction of new attributes) while aligning those structural changes with versioned data dictionaries and mapping specifications.

The system's data security framework protects digital information from unauthorized access, theft, or corruption. Identity Access Management (IAM) grants secure access to the system to verified entities, ideally with a bare minimum of interference. The goal is to manage access in a way that ensures authorized individuals can perform their tasks while preventing unauthorized users, such as hackers, from gaining access. Granting secure access to an organization's resources involves two main components: identity management and access management (role-based access control). Granting the correct level of access after a user's identity is authenticated is called authorization. The goal of the IAM system is to make sure that authentication and authorization happen correctly and securely at every access attempt.

In one embodiment, the system enforces least-privilege principles by scoping visibility and actions for objects carrying data-privacy flags, including personally identifiable information, payment card information, or employee-related data. Sensitive operations (e.g. such as viewing detailed trading records or customer identity attributes) require explicit authorization before content is revealed. Where access is permitted, sensitive fields may be masked in the user interface so that analysts can perform required tasks while protected values remain obscured. The masking approach may be format-preserving where appropriate to preserve analytical utility.

In one embodiment, the data governance framework records detailed information about data access, modifications, and movement within the system by tracking the “trace” of a data request as it travels through different components, allowing security teams to identify potential threats and suspicious activity by monitoring how data is being accessed and manipulated across the system, essentially providing a comprehensive view of data flow for enhanced security analysis.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for integrating source data into a target application, the method comprising:
connecting to a designated source system and retrieving metadata associated with a plurality of source objects;
analyzing, using an artificial-intelligence model, the metadata to determine structural characteristics, data-quality indicators, and interrelationships among the plurality of source objects;
generating, using the artificial intelligence model and based on the determined structural characteristics, data-quality indicators, and
interrelationships, and at least one candidate source-to-target mapping for the target application;
determining whether the at least one candidate source-to-target mapping satisfies at least one requirement of a target schema of the target application;
codifying, when the at least one candidate source-to-target mapping
satisfies the at least one requirement, a data-transformation pipeline configured to transform the source data and load the transformed data into the target application; and
loading the transformed data into the target application.

2. The method of claim 1, further comprising assigning a governance designation to at least one source object based on the structural characteristics and data-quality indicators.

3. The method of claim 1, further comprising generating an entity-relationship diagram representing the interrelationships among the plurality of source objects.

4. The method of claim 1, further comprising generating functional descriptions assigning semantic meaning to the plurality of source objects.

5. The method of claim 1, further comprising flagging any candidate source-to-target mapping having a confidence score below a configurable threshold.

6. The method of claim 1, wherein the method is performed fully automatically by the artificial-intelligence model.

7. A computer-implemented system comprising a memory and one or more processors configured to:
connect to a designated source system and retrieving metadata associated with a plurality of source objects;
analyze, using an artificial-intelligence model, the metadata to determine structural characteristics, data-quality indicators, and interrelationships among the plurality of source objects;
generate, using the artificial intelligence model and based on the
determined structural characteristics, data-quality indicators, and
interrelationships, and at least one candidate source-to-target mapping for a target application;
determine whether the at least one candidate source-to-target mapping satisfies at least one requirement of a target schema of the target application;
codify, when the at least one candidate source-to-target mapping satisfies
the at least one requirement, a data-transformation pipeline configured to transform the source data and load the transformed data into the target application; and
load the transformed data into the target application.

8. The system of claim 7, further comprising assigning a governance designation to at least one source object based on the structural characteristics and data-quality indicators.

9. The system of claim 7, further comprising generating an entity-relationship diagram representing interrelationships among the plurality of source objects.

10. The system of claim 7, further comprising generating functional descriptions that assign semantic meaning to the plurality of source objects.

11. The system of claim 7, further comprising flagging any candidate source-to-target mapping having a confidence score below a configurable threshold.

12. The system of claim 7, wherein the method is performed fully automatically by the artificial-intelligence mode.
